(19) United States
(12) Patent Application Publication
(10) Pub. No.: US 2023/0405945 A1
(43) Pub. Date: Dec. 21, 2023

(54) MOLDING METHOD

(71) Applicant: TOYOTA JIDOSHA KABUSHIKI KAISHA, Toyota-shi (JP)

(72) Inventors: Hidetoshi YOMODA, Okazaki-shi (JP); Riyo SATAKE, Toyota-shi (JP)

(73) Assignee: TOYOTA JIDOSHA KABUSHIKI KAISHA, Toyota-shi (JP)

(21) Appl. No.: 18/251,754

(22) PCT Filed: Nov. 27, 2020
(86) PCT No.: PCT/JP2020/044158

§ 371 Date: May 4, 2023

(51) Int. Cl. B29C 70/44; B29C 51/10; B29C 51/30; B29C 51/36; B29C 51/42; B29C 70/54

(52) U.S. Cl. CPC B29C 70/44; B29C 51/10; B29C 51/303; B29C 51/36; B29C 51/42; B29C 70/542; B29K 2309/08

(57) ABSTRACT

A molding method according to the present invention is a molding method for molding a prepreg by adhering the prepreg to a first mold including an irregular surface, the molding method including the steps of: placing the prepreg on the irregular surface of the first mold; placing, on the prepreg, an elastic sheet including a protrusion having a tip end shape that follows a shape of a recess of the irregular surface; and sealing a space between the first mold on which the prepreg is placed and the elastic sheet, and vacuum suction the space, in which in the vacuum suction step, the prepreg located in the recess is pressed by the protrusion included in the elastic sheet and adheres to the surface of the first mold (11).

### TECHNICAL FIELD

The present invention relates to a molding method.

### BACKGROUND ART

It is known that a prepreg obtained by impregnating a carbon fiber with thermosetting resin can be molded by an autoclave molding method. As an autoclave molding method of a prepreg, Patent Literature 1 discloses a molding method in which a prepreg placed on a lower mold is covered with a silicone rubber sheet and a space between the lower mold and the silicone rubber sheet is vacuum-sucked.

### CITATION LIST

### Patent Literature

Patent Literature 1: Japanese Unexamined Patent Application Publication No. 2001-047507

### SUMMARY OF INVENTION

### Technical Problem

The inventors found that the following problem occurs when a prepreg is molded using a lower mold and an elastic sheet such as a silicone rubber sheet. Specifically, there is a problem that in a case where the prepreg needs to be molded into a complex shape, the prepreg does not adhere to the mold at a recessed part of the lower mold having a complex shape even after vacuum suction, and a high transfer property cannot be obtained.

The present invention has been made in view of the above problem, and provides a molding method that can achieve a high transfer property.

### Solution to Problem

A molding method according to the present invention is a molding method for molding a prepreg by adhering the prepreg to a first mold including an irregular surface, the molding method including the steps of:
placing the prepreg on the irregular surface of the first mold;
placing, on the prepreg, an elastic sheet including a protrusion having a tip end shape that follows a shape of a recess of the irregular surface; and
sealing a space between the first mold on which the prepreg is placed and the elastic sheet, and vacuum suction the space,
in which in the vacuum suction step, the prepreg located in the recess is pressed by the protrusion included in the elastic sheet and adheres to the irregular surface of the first mold.

In the molding method according to the present invention, in the vacuum suction step, the prepreg located in the recess is pressed by the protrusion included in the elastic sheet and adheres to the irregular surface of the first mold. Hence, it is possible to provide a molding method that can achieve a high transfer property.

### Advantageous Effects of Invention

The present invention can provide a molding method that can achieve a high transfer property.

### BRIEF DESCRIPTION OF DRAWINGS

FIG. 1 is a flowchart illustrating the flow of a molding method according to the present embodiment;

FIG. 2 is a perspective view illustrating a state where a prepreg is placed on a first mold in the molding method according to the present embodiment;

FIG. 3 is a front view illustrating a state where an elastic sheet is placed on the prepreg in the molding method according to the present embodiment;

FIG. 4 is an enlarged view of a region indicated by IV in FIG. 3 after performing vacuum suction in the molding method according to the present embodiment;

FIG. 5 is a diagram of an analysis model illustrating a state where vacuum suction has been performed in a simulation using CAE in the molding method according to the present embodiment;

FIG. 6 is an enlarged front section illustrating a section taken along VI-VI of FIG. 5; and

FIG. 7 is a diagram of an analysis model illustrating a state where the position of a recess in FIG. 6 has been identified.

### DESCRIPTION OF EMBODIMENT

Hereinafter, a specific embodiment of the present invention will be described in detail with reference to the drawings.

Note that the right-handed coordinate system illustrated in the drawings are provided to simplify the description of the positional relationship among components. The positive direction of the z axis is the vertically upward direction unless otherwise specified. The xy plane is the horizontal plane.

### Embodiment

A molding method according to the present embodiment is a molding method in which a prepreg is molded by adhering the prepreg to a first mold including an irregular surface. That is, the method is a molding method of transferring the shape of the irregular surface of the first mold onto the prepreg. Here, the prepreg as the molding target is obtained by impregnating a fiber with thermosetting resin. Examples of the fiber include carbon fiber and glass fiber. Note that in the molding method according to the present embodiment, a plurality of prepregs can be laminated and be molded in this state.

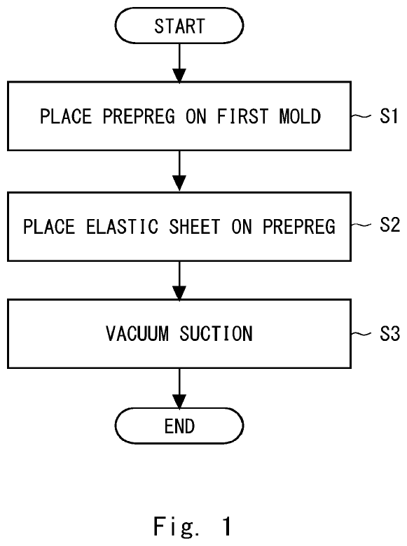

FIG. 1 is a flowchart illustrating the flow of the molding method according to the present embodiment. As illustrated in FIG. 1, in the molding method according to the present embodiment, first, a prepreg is placed on an irregular surface of a first mold (step S1). Next, an elastic sheet including a protrusion having a tip end shape that follows the shape of a recessed part of the irregular surface of the first mold is placed on the prepreg (step S2). Subsequently, a space between the first mold on which the prepreg is placed and the elastic sheet is sealed and the space is vacuum-sucked (step S3).

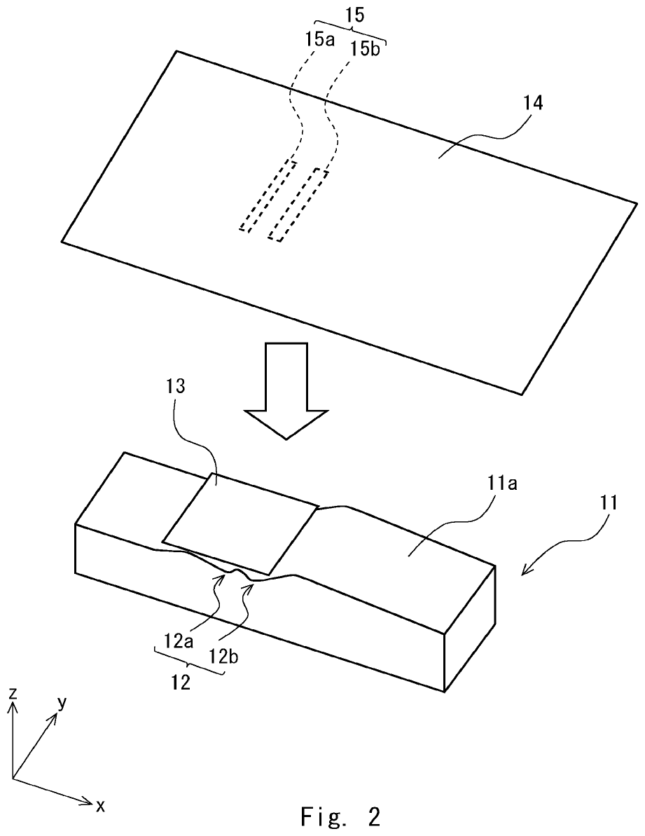

Hereinafter, the steps described above will be described with reference to FIGS. 2 to 4 corresponding to the steps in FIG. 1.

### <Step S1: Place Prepreg on First Mold>

In step S1, a prepreg 13 is placed on a first mold 11.

FIG. 2 is a perspective view illustrating a state where the prepreg 13 is placed on the first mold 11 in the molding method according to the present embodiment.

As illustrated in FIG. 2, the first mold 11 is a mold having an irregular surface 11a on an upper surface (xy plane on positive side of z axis) thereof. The irregular surface 11a of the first mold 11 has an arbitrary desired shape. As illustrated in FIG. 2, the irregular surface 11a of the first mold 11 has a recess 12a and a recess 12b, for example.

The first mold 11 may be made of a metal such as aluminum, iron, stainless steel, and an alloy, a thermoplastic resin such as polypropylene resin and polyethylene resin, a thermosetting resin such as epoxy resin and urethane resin, or a fiber reinforced plastic such as carbon fiber reinforced plastic (CFRP) and glass fiber reinforced plastic (GFRP). The first mold 11 may be made by using heat-resistant and pressure-resistant materials among the above materials.

As illustrated in FIG. 2, the prepreg 13 is placed on the irregular surface 11a of the first mold 11. Note that while the prepreg 13 illustrated in FIG. 2 is placed on a part of the irregular surface 11a of the first mold 11, the length in the x-axis direction and the width in the y-axis direction of the prepreg 13 can be appropriately changed according to the size of the desired molded product.

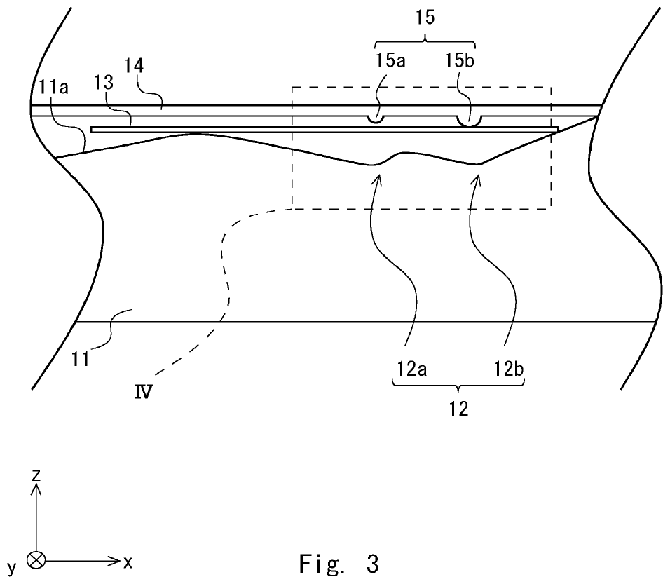

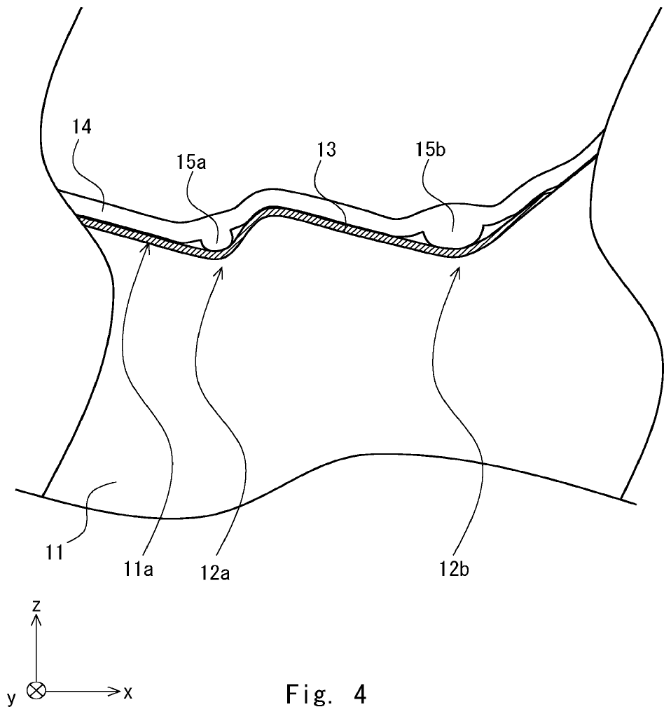

In the subsequent step S2, an elastic sheet 14 including protrusions 15 is placed on the prepreg 13. As illustrated in FIG. 2, the widths in the x-axis direction and the y-axis direction of the elastic sheet 14 are set to be larger than those of the prepreg 13. In other words, the widths in the x-axis direction and the y-axis direction of the elastic sheet 14 are large enough to at least cover the prepreg 13. Details of the protrusions 15 will be described later with reference to FIGS. 3 and 4. Note that the size of the elastic sheet 14 may be large enough to cover the entire first mold 11 as illustrated in FIG. 2.

### <Step S2: Place Elastic Sheet on Prepreg>

In step S2, the elastic sheet is placed on the prepreg.

FIG. 3 is a front view illustrating a state where the elastic sheet 14 is placed on the prepreg 13 in the molding method according to the present embodiment. As illustrated in FIG. 3, the elastic sheet 14 includes protrusions 15a, 15b having tip end shapes that follow the shapes of the recesses 12a, 12b of the irregular surface 11a of the first mold 11. The elastic sheet 14 is placed on the prepreg 13 so that the positions of the recess 12a and the protrusion 15a and the positions of the recess 12b and the protrusion 15b coincide with each other.

The material of the elastic sheet 14 and the protrusions 15 is an elastic body. More specifically, the elastic sheet 14 is configured of silicone rubber, styrene-butadiene rubber (SBR), chloroprene rubber (CR), acrylonitrile rubber (NBR), butyl rubber, ethylene-propylene rubber, fluoro-rubber, or a combination of these, for example.

The protrusions 15 may be formed integrally with the elastic sheet 14, or may be separate bodies that can be attached to the elastic sheet 14 by bonding or fitting. In the case of attaching the protrusions by fitting, the elastic sheet 14 may have connecting holes into which the protrusions can be fitted.

In the case where the protrusions 15 are formed integrally with the elastic sheet 14, the protrusions 15 may be configured of the same material as the material of the elastic sheet 14. In the case where the protrusions 15 are separate bodies that can be attached to the elastic sheet 14, the protrusions 15 may be configured of the same material or may each be configured of a different arbitrary material.

As described above, the materials of the elastic sheet 14 and the protrusions 15 are both an elastic body. Note, however, that at the time of vacuum suction in the next step S3, the elastic sheet 14 is deformable, whereas the protrusions 15 are hardly deformed. In the case where the elastic sheet 14 and the protrusions 15 are separate bodies, the elastic sheet 14 may be formed of a material having an easily deformable elastic modulus, for example. On the other hand, the protrusions 15 may be formed of a material with which the prepreg 13 can be easily pressed, that is, a material having an elastic modulus less deformable than the elastic sheet 14. Moreover, the elastic sheet 14 may be provided with a suction hole (not illustrated) connectable to equipment for performing vacuum suction.

As illustrated in FIG. 3, the recesses 12 and the protrusions 15 are formed into a shape having a curvature. The radius of curvature of the protrusions 15 is preferably equal to or less than the radius of curvature of the recesses 12. Furthermore, the radius of curvature of the protrusions 15 is more preferably equal to or greater than half of the radius of curvature of the recesses 12. As a specific example, when the radius of curvature of the recess 12a is 3 mm, the radius of curvature of the protrusion 15a may be 2 mm. Similarly, for example, when the radius of curvature of the recess 12b is 10 mm, the radius of curvature of the protrusion 15b may be 5 mm.

### <Step S3: Vacuum Suction>

In step S3, a space between the first mold on which the prepreg is placed and the elastic sheet is sealed, and the space is vacuum-sucked. The sealing between the first mold 11 and the elastic sheet 14 may be done by performing bagging so as to cover the first mold 11 and the elastic sheet 14 as a whole, or by sealing the border between the first mold 11 and the elastic sheet 14. In the case of sealing the border between the first mold 11 and the elastic sheet 14, a resin film or a frame configured of resin or metal, for example, may be used for the sealing.

FIG. 4 is an enlarged view of a region indicated by IV in FIG. 3 after performing vacuum suction in the molding method according to the present embodiment. As illustrated in FIG. 4, the prepreg 13 located in the recesses 12a, 12b of the first mold 11 are respectively pressed by the protrusions 15a, 15b included in the elastic sheet 14 and adhere to the irregular surface 11a of the first mold 11. Note that in FIG. 4, the prepreg 13 is indicated by diagonal hatching lines upward from left to right for emphasis.

Note that while the prepreg 13 is placed on the first mold 11 and the elastic sheet 14 is placed on the prepreg 13 in the present embodiment, the invention is not limited thereto. For example, each process may be performed with the first mold tilted in an arbitrary direction depending on the situation. Alternatively, the prepreg 13 may be heated in advance and be softened before molding to facilitate the molding.

The flow of the molding method according to the present embodiment has been described above.

The molding method according to the present embodiment may further include a step of autoclave molding (not illustrated) in which the prepreg is heated using a second mold. The second mold is a mold formed so as to fit into the first mold, and is manufactured from a heat-resistant and pressure-resistant material. After the vacuum suction step described above, the elastic sheet is removed. Then, the prepreg is sandwiched by the first mold and the second mold to be heated. At this time, the prepreg may be moved to a heat-resistant and pressure-resistant third mold having the same shape as the first mold, and then be sandwiched by the third mold and the second mold. On the other hand, in the case of using a first mold manufactured using a heat-resistant and pressure-resistant material, the prepreg can be heated without being moved to a third mold, and therefore molding can be performed efficiently.

In the molding method according to the present embodiment, to mold the protrusion of the elastic sheet used for molding, the processes up to the vacuum suction process using the elastic sheet without the protrusion may be performed, and then the position of the recess of the first mold may be identified to provide the protrusion in this position. However, a different step may be included. For example, a step may be further included in which the position of a recess shape of the first mold is identified in advance by analysis using computer simulation such as computer aided engineering (CAE) analysis, and a protrusion of the elastic sheet is formed so as to follow the identified recess shape. The position of the recess shape of the first mold may be analyzed by using various methods such as the finite element method, the finite difference method, the finite volume method, and the particle method. A plurality of kinds of these numerical analysis techniques may be combined as needed.

First, various parameters are input into a computer to create an analysis model using CAE. Examples of the parameter include the shape of the first mold, the number of laminations of the prepreg, the angle of direction of fiber forming the prepreg, the elastic modulus of the prepreg, in the case of laminating a plurality of prepregs, the coefficient of friction on the surface where the prepregs are in contact with each other, the coefficient of friction between the prepreg and the first mold, the coefficient of friction between the prepreg and the elastic sheet, and the elastic modulus of rubber.

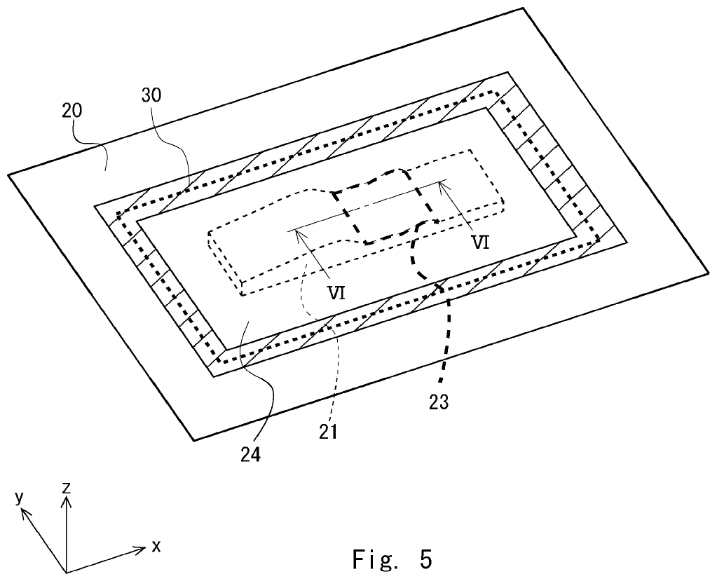

Hereinafter, a description will be given with reference to FIGS. 5 to 7.

FIG. 5 is a diagram of an analysis model illustrating a state where vacuum suction has been performed in a simulation using CAE in the molding method according to the embodiment. The analysis model illustrated in FIG. 5 was created by the finite element method, for example. A first mold 21 is placed on a base 20. A prepreg 23 is placed on an irregular surface of the first mold 21, and an elastic sheet 24 is placed on the prepreg 23. The outer periphery of the elastic sheet 24 is sealed using a sealing member 30 that can seal the gap between the first mold 21 and the elastic sheet 24. FIG. 5 illustrates a state where the sealed space between the first mold 21 on which the prepreg 23 is placed and the elastic sheet 24 has been vacuum-sucked. There is no protrusion in the elastic sheet 24 in FIG. 5.

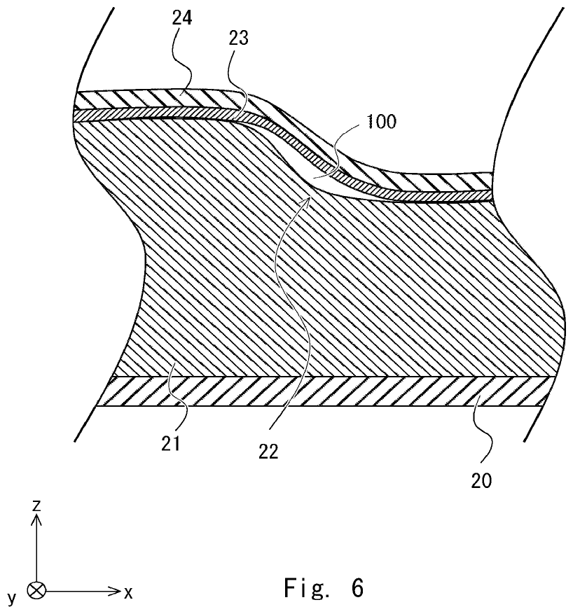

FIG. 6 is an enlarged front section illustrating a section taken along line VI-VI of FIG. 5. As illustrated in FIG. 6, in a case where the elastic sheet 24 with no protrusion is used, a recess 22 and the prepreg 23 are not adhered to each other and are separate, whereby a void 100 is generated.

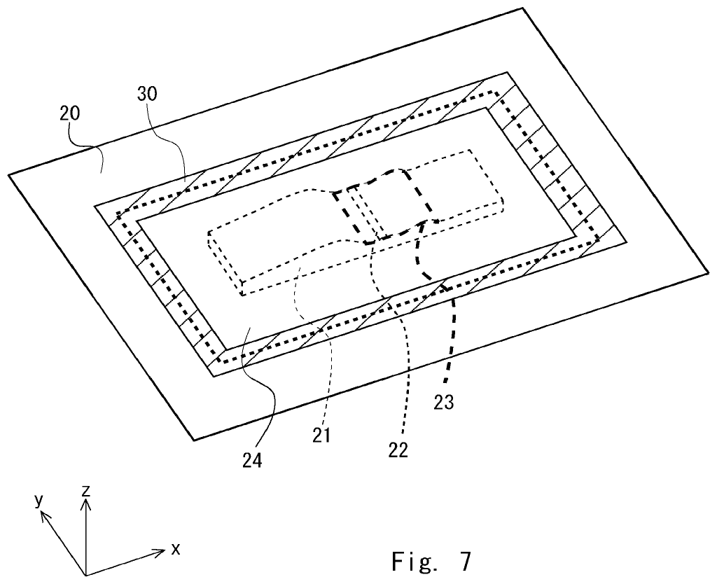

FIG. 7 is a diagram of an analysis model illustrating a state where the position of the recess 22 in FIG. 6 has been identified. As illustrated in FIG. 7, a protrusion is provided in the identified position of the recess 22. More specifically, with the position of the recess 22 identified in a simulation using CAE analysis, the elastic sheet 24 is returned to the state before vacuum suction. In the position of the recess 22 on the elastic sheet 24 returned to a flat shape, a protrusion thick enough to press the void 100 is provided so as to follow the shape of the recess 22. By using CAE in this manner, it is possible to provide a protrusion that can press the void 100 and adhere the prepreg 23 to the recess 22.

The inventors found that the following problem occurs when a prepreg is molded using a lower mold and an elastic sheet such as a silicone rubber sheet. Specifically, there is a problem that in a case where the prepreg needs to be molded into a complex shape, the prepreg does not adhere to the mold at a recessed part of the lower mold having a complex shape even after vacuum suction, and a high transfer property cannot be obtained.

Against background, in the molding method according to the present embodiment in the vacuum suction step, the prepreg located in the recessed part is pressed by the protrusion included in the elastic sheet and adheres to the irregular surface of the first mold. Hence, it is possible to provide a molding method that can achieve a high transfer property.

Since the molding method according to the present embodiment can achieve a high transfer property, it is possible to curb projection of the prepreg into the recess at the time of molding. Hence, the prepreg can be kept from being damaged when it is fitted into the second mold in a later step.

Additionally, the molding method according to the present embodiment uses the elastic sheet in which the protrusion is provided only in a part corresponding to the recess where pressing is required, and no additional part is required for any other part. Hence, it is also possible to curb cost for molding.

Additionally, in the molding method according to the present embodiment, the protrusion is configured of the same material as the elastic sheet and is formed integrally with the elastic sheet.

Accordingly, it is possible to form the elastic sheet including the protrusion easily. On the other hand, in a case where the protrusion is a separate body that can be attached to the elastic sheet, the position of the protrusion can be finely adjusted every time the protrusion is formed. Moreover, in a case where the elastic sheet and the protrusion are configured of different materials, the elastic sheet may have a more deformable elastic modulus and the protrusion may have an elastic modulus less deformable than the elastic sheet. Accordingly, the protrusion can easily press the prepreg, and the prepreg can be accurately adhered along the shape of the recess.

Additionally, in the molding method according to the present embodiment, the recess and the protrusion are formed into a shape having a curvature, and the radius of curvature of the protrusion is equal to or less than the radius of curvature of the recess. Furthermore, the radius of curvature of the protrusion is more preferably equal to or greater than half of the radius of curvature of the recess. Accordingly, the protrusion can press the prepreg accurately and the prepreg can be accurately adhered so as to follow the shape of the recess.

Moreover, the molding method according to the present embodiment further includes a step of removing the elastic sheet with the prepreg adhered to the irregular surface of the first mold after vacuum suction, sandwiching the prepreg by the first mold and the second mold formed so as to fit into the first mold, and heating the prepreg. Accordingly, even if there is a part where the prepreg is not adhered to the recess of the first mold by being pressed by the protrusion, the prepreg can be adhered to the recess more securely. Accordingly, the molding accuracy can be improved.

In addition, the molding method according to the present embodiment further includes a step of identifying the position of the recess shape of the first mold in advance by CAE analysis, and forming the protrusion of the elastic sheet so as to follow the shape of the identified recess. Accordingly, in order to identify the position of the recess, there is no need to perform an actual test using an elastic sheet with no first mold and protrusion. Instead, it is possible to identify the position of the recess beforehand in a computer simulation. As a result, it is possible to form a protrusion in a necessary place without performing an actual test. In the case of identifying the position and shape of the recess of the first mold by CAE analysis, the position and shape of the recess can be easily identified even if the first mold has a complex shape. Hence, the protrusion can be formed easily as compared to the case of performing an actual test.

Note that the present invention is not limited to the above embodiment, and appropriate changes can be made within the scope of the invention.

### REFERENCE SIGNS LIST

11 FIRST MOLD
11a IRREGULAR SURFACE
12, 12a, 12b RECESS
13 PREPREG
14 ELASTIC SHEET
15, 15a, 15b PROTRUSION
20 BASE
21 FIRST MOLD
22 RECESS
23 PREPREG
24 ELASTIC SHEET
30 SEALING MEMBER
100 VOID

1. A molding method for molding a prepreg by adhering the prepreg to a first mold including an irregular surface, the molding method comprising the steps of:
placing the prepreg on the irregular surface of the first mold;
placing, on the prepreg, an elastic sheet including a protrusion having a tip end shape that follows a shape of a recess of the irregular surface; and
sealing a space between the first mold on which the prepreg is placed and the elastic sheet, and vacuum suction the space,
wherein in the vacuum suction step, the prepreg located in the recess is pressed by the protrusion included in the elastic sheet and adheres to the irregular surface of the first mold.

2. The molding method according to claim 1, wherein the protrusion is configured of the same material as a material of the elastic sheet, and is formed integrally with the elastic sheet.

3. The molding method according to claim 1, wherein the protrusion is configured of a material different from a material of the elastic sheet, and is a separate body that can be attached to the elastic sheet.

4. The molding method according to claim 1, wherein the recess and the protrusion are formed into a shape having a curvature, and a radius of curvature of the protrusion is equal to or less than a radius of curvature of the recess.

5. The molding method according to claim 4, wherein the radius of curvature of the protrusion is equal to or greater than half of the radius of curvature of the recess.

6. The molding method according to claim 1, further comprising a step of removing the elastic sheet with the prepreg adhered to the irregular surface of the first mold after the vacuum suction, sandwiching the prepreg by the first mold and a second mold formed so as to fit into the first mold, and heating the prepreg.

7. The molding method according to claim 1, further comprising a step of identifying a position of the recess of the first mold in advance by CAE analysis, and forming the protrusion of the elastic sheet so as to follow a shape of the identified recess.
